(19) United States
(12) Patent Application Publication
(10) Pub. No.: US 2007/0262209 A1
(43) Pub. Date: Nov. 15, 2007

(54) Support structure for display device

(75) Inventors: Wei Shin She, Taipei County (TW); Shih Hsiu Huang, Taoyuan County (TW)

Correspondence Address: QUINTERO LAW OFFICE, PC, 2210 MAIN STREET, SUITE 200, SANTA MONICA, CA, 90405, US

(73) Assignee: BENQ CORPORATION, Taoyuan (TW)

(21) Appl. No.: 11/528,081

(22) Filed: Sep. 27, 2006

(30) Foreign Application Priority Data
May 15, 2006 (TW) TW95117157

(51) Int. Cl. F16M 11/00

(52) U.S. Cl. 248/122.1

(57) ABSTRACT

A support structure comprises a connecting element slidably disposed on a display device, and a support element joined to the connecting element allows adjustment of an inclined angle of the display device. When the support element is fixed to a predetermined position other than the display device, the display device is capable of moving up and down with respect to the position.

### BACKGROUND OF THE INVENTION

1. Field of the Invention

The invention relates to a support structure for a display device, and in particular to a support structure disposed on the back of a display device enabling the display device to move up and down when the display device hangs on a wall whether there is no mount.

2. Description of the Related Art

A conventional support structure for a display device is shown in FIG. 1. The display device (not shown) is connected to a support element 20 connected to a bracket 10 via a connecting element 30. The connecting element 30 comprises a first portion 32 and a second portion 34. The first portion 32 is rotatably connected to the second portion 34 and joined to the support element 20. The second portion 34 engages a track 20 on the bracket 10 and slides on the track 20, whereby the connecting element 30 is capable of sliding on the bracket 10 and enables the support element 20 to move up and down on the bracket 10. The display device fixed on the support element 20 moves to a desired position. As the first portion 32 is rotatably joined to the second portion 34, the support element 20 connected to the first portion 32 is adjusted to a desired angle with respect to the bracket 10. In addition, the first portion 32 is rotatably joined to the support element 20, whereby the support element 20 is rotated clockwise or counterclockwise relative to the first portion 32. The support element 20 is rotated clockwise or counterclockwise relative to the bracket 10, whereby the display device rotates clockwise or counterclockwise relative to the bracket 10.

If the display device is dissembled from the support structure and fixed on a wall, the display device can no longer be moved, angle-adjusted, nor rotated as said above..

### BRIEF SUMMARY OF INVENTION

An embodiment of a support structure of the invention comprises a connecting element slidably disposed on the display device, and a support element joined to the connecting element to provide adjustment of an inclined angle of the display device. When the support element is fixed to a predetermined position, the display device is capable of moving up and down with respect to the position.

The connecting element comprises a first portion rotatably connected to the support element, and a second portion slidably disposed on the display device and rotatably connected to the first portion, wherein the display device rotates clockwise or counterclockwise with respect to the support element via the first portion, and the inclined angle of the display device is adjusted via the second portion.

The display device employing the support structure can be fixed on a bracket or a wall.

### BRIEF DESCRIPTION OF DRAWINGS

The invention can be more fully understood by reading the subsequent detailed description and examples with references made to the accompanying drawings, wherein:

FIG. 1 is a schematic view of a conventional support structure for a display device;

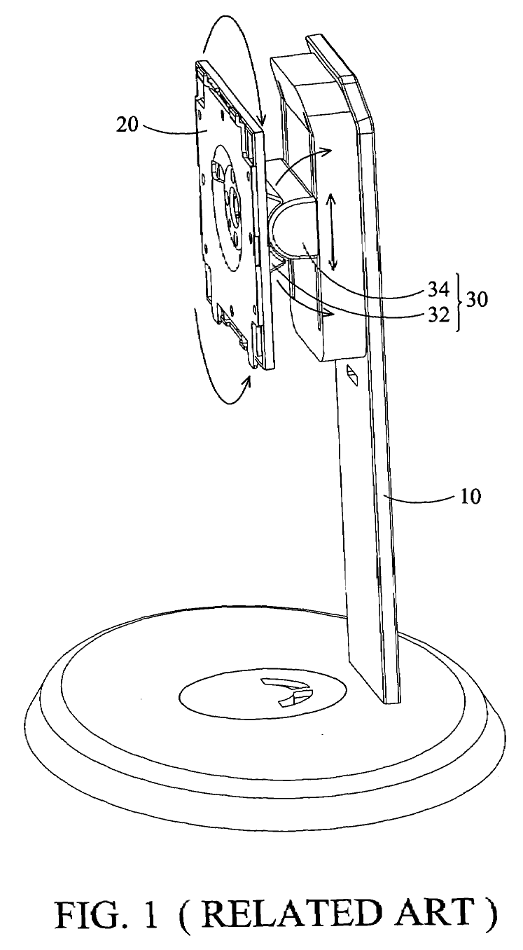

FIG. 2 is a perspective view of a support structure for a display device of the invention;

FIG. 3a is a schematic view of the connecting element and the support element of FIG. 2;

FIG. 3b is an exploded view of the connecting element and the support element of FIG. 2;

FIG. 4 is a perspective exploded view of the support stucture of the invention fixed to a bracket;

FIG. 5 is a schematic view of the support structure of the invention with the display device rising;

FIG. 6 is a schematic view of the support structure of the invention with the display device descending;

FIG. 7 is a schematic view of the support structure of the invention fixed to a wall;

FIG. 8 is a schematic view of an embodiment of an elevation mechanism of the invention;

FIG. 9 is a schematic view of another embodiment of an elevation mechanism of the invention; and

FIG. 10 is a schematic view of another embodiment of an elevation mechanism of the invention.

### DETAILED DESCRIPTION OF INVENTION

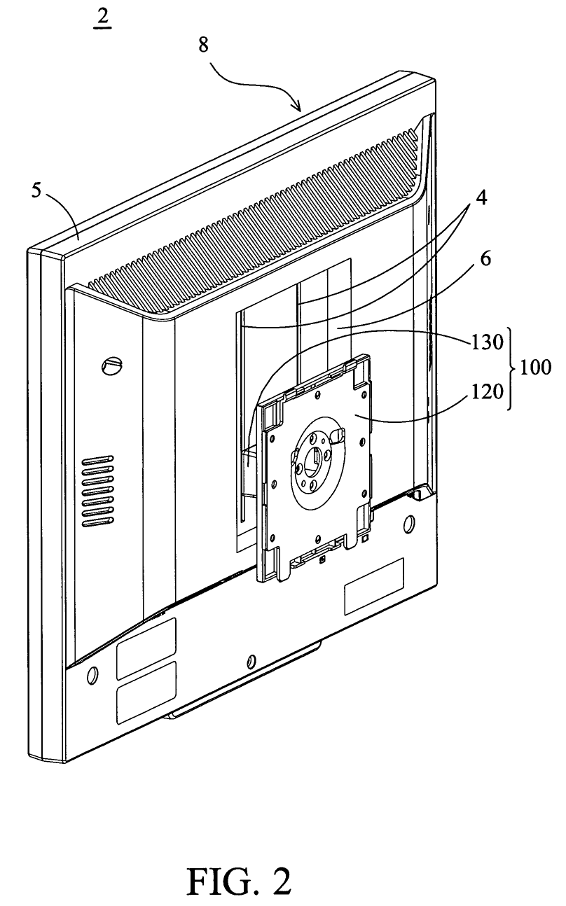

Referring to FIG. 2, a support structure 100 comprises a support element 120 and a connecting element 130. The support element 120 is a plate and can be secured to a desired position, such as a bracket or a wall. The connecting element 130 is disposed on a back housing 5 of a main body 8 of the display device 2, as shown in FIG. 2. A rectangular recess 6,in which the connecting element 130 is disposed, is formed on the back housing 5. A groove 4 is formed on the recess 6. The connecting element 130 is engaged with the groove 4, whereby the connecting element 130 is capable of sliding in the recess 6. An elevation mechanism (not shown) is disposed in the display device 2. One end of the connecting element 130is connect to the elevation mechanism by passing through the groove 4. The connecting element 130 is moved up and down in the recess 6 by the elevation mechanism.

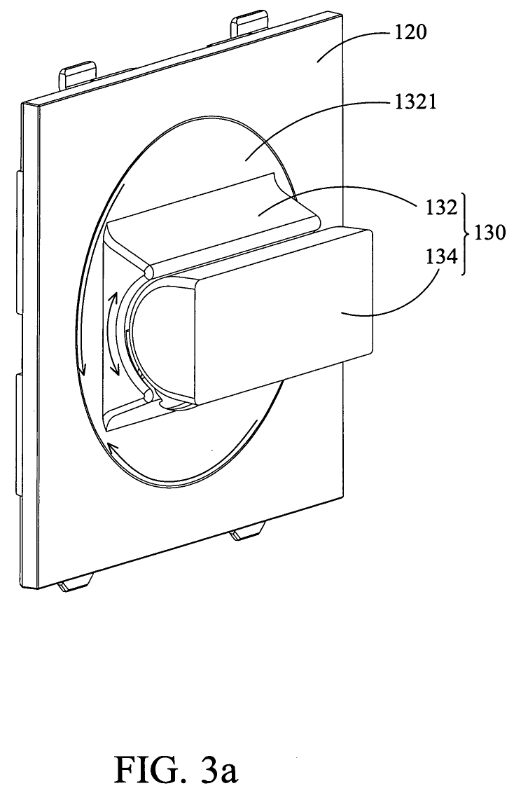

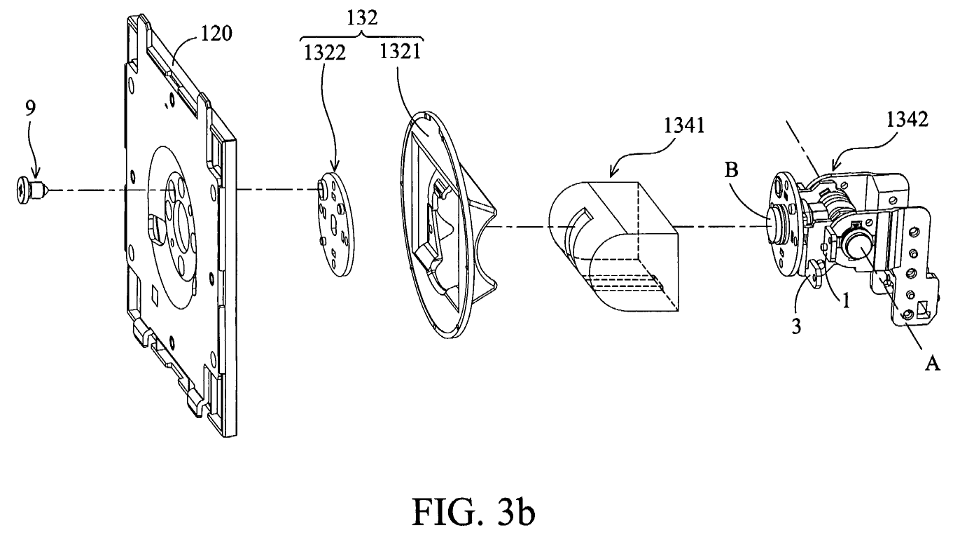

Referring to FIGS. 3a and 3b, the connecting element 130 comprises a first portion 132 and a second portion 134. The first portion 132 comprises a disc-shaped rotating portion 1321 and a disc 1322. The second portion 134 comprises a cover 1341 and a pivot mechanism 1342. The rotating portion 1321 and the cover 1341 are joined to the pivot mechanism 1342 via a flange 3 and a flange 1. The cover 1341 has a curved prominent front, and the rotating portion 1321 has a concave portion. The curved prominent front engages the concave portion. A shaft B of the pivot mechanism 1342 is rotatably joined to the support element 120, whereby the first portion 132 rotates about the shaft B relative to the support element 120, clockwise or counterclockwise. The disc 1322 is joined to the support element 120 by a bolt 9 to constrain the support element 120 to rotate to 90° clockwise or counterclockwise. As the pivot mechanism 1342 has a shaft A and the rotating portion 1321 and the cover 1341 are joined to one side of the shaft A, the first portion 132 rotates about the shaft A relative to the second portion 134. The display device 2 rotates clockwise or counterclockwise relative to the support element 120 to adjust the angle relative to the support element 120.

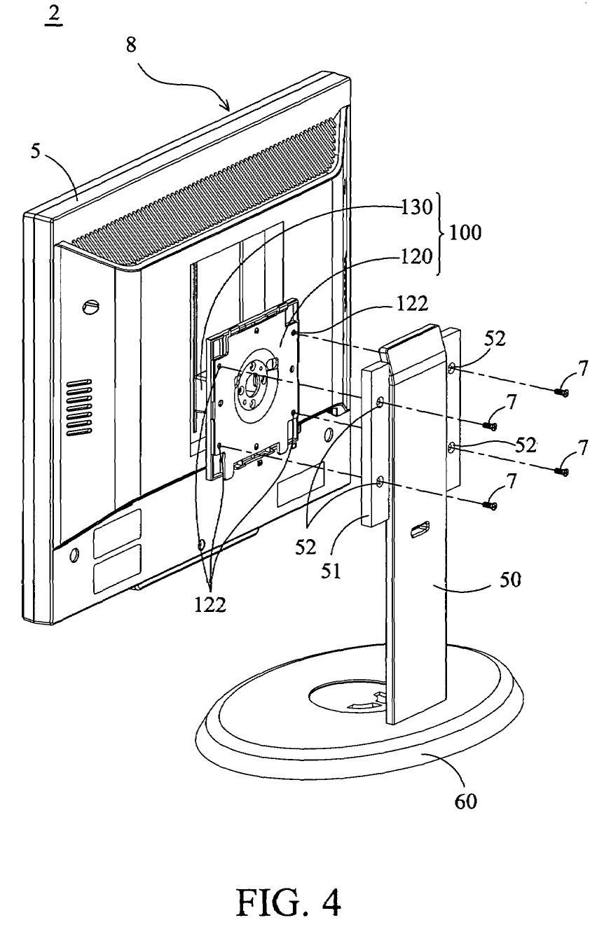

The support element 120 is fixed to a bracket 50 as shown in FIG. 4. A plate 51 is disposed on the bracket 50. A plurality of through holes 52 are formed on the plate 51. Screw holes 122 corresponding to the through holes 52 are formed on the support element 120. A bolt 7 passes through the through hole 52 and screwed into the screw hole 122, whereby the support element 120 is fixed to the plate 51. The bracket 50 is perpendicularly fixed to a base 60, whereby the bracket 50 is maintained perpendicularly to the base 60.

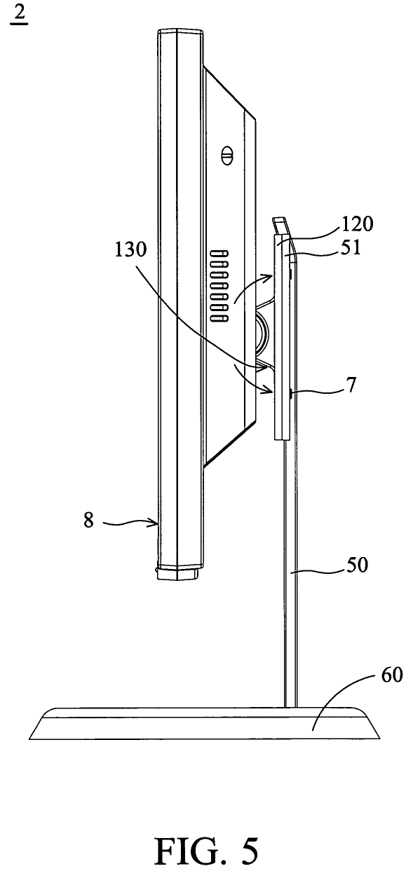

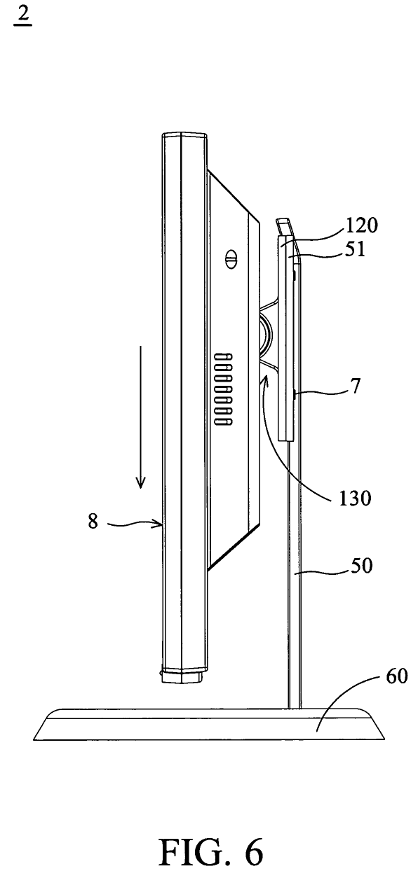

When the support element 120 is fixed to the bracket 50, an elevation mechanism in the display device 2 moves the display device 2 up or down relative to the connecting element 130 (support element 120 can rotate rather than move relative to the connecting element 130) to move the main body 8 of the display device 2 up and down relative to the bracket 50, as shown in FIGS. 5 and 6. FIG. 5 depicts the main body 8 rising, and FIG. 6 depicts the main body 8 descending. The main body 8 can rotate clockwise or counterclockwise relative to the bracket 50. The angle of the main body 8 can also be adjusted to an appropriate angle.

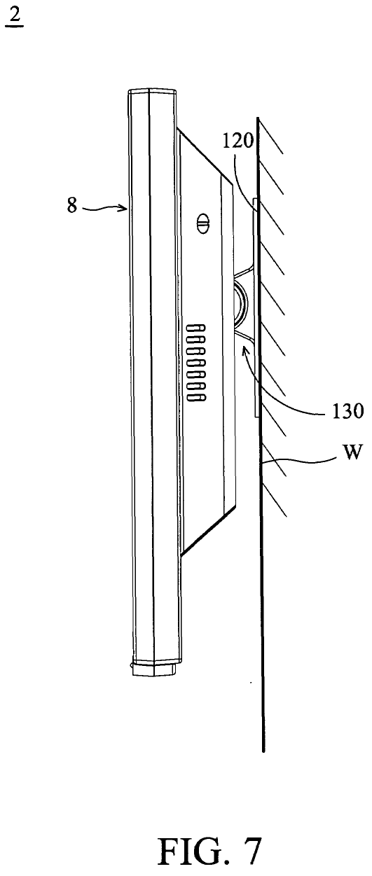

When the display device 2 is dissembled from the bracket 50 and fixed to a wall W, as shown in FIG. 7, the support element 120 is fixed to the wall W. As the display device 2 can move relative to the support element 120, the display device 2 moves or rotates relative to the wall W. The angle of the display device 2 with respect to the wall W can also be adjusted.

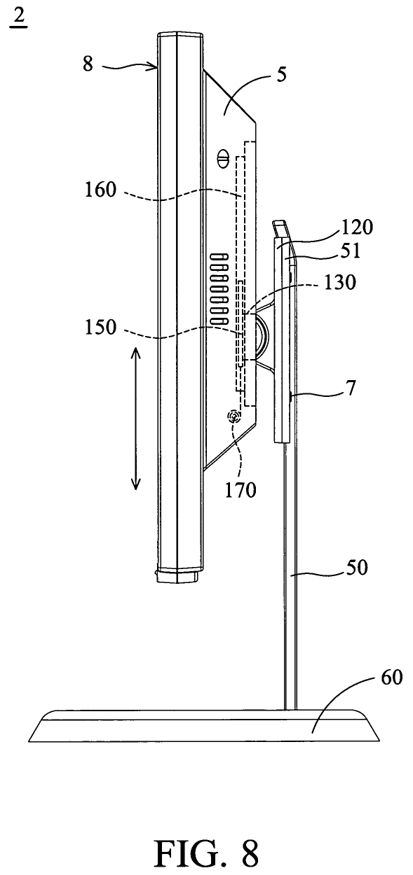

FIGS. 8, 9 and 10 depict three embodiments of the elevation mechanism.

In FIG. 8, the elevation mechanism comprises a guide element 150, a track 160 and a constant force spring 170. The guide element 150 is a rectangular plate joined to the connecting element 130. The track 160 is a groove disposed on the back housing 5. The guide element 150 engages the track 160 and slides therein. The constant force spring 170 is disposed on the back housing 5 with one end joined to the guide element 150. When the support element 120 and the connecting element 130 are fixed to the bracket 50 or wall W, the main body 8 can move up and down. At this time, the track 160 moves relative to the guide element 150. The constant force element 170 pulls the display device 2 to balance the weight of the display device 2, whereby the display device 2 can stay in an arbitrary position.

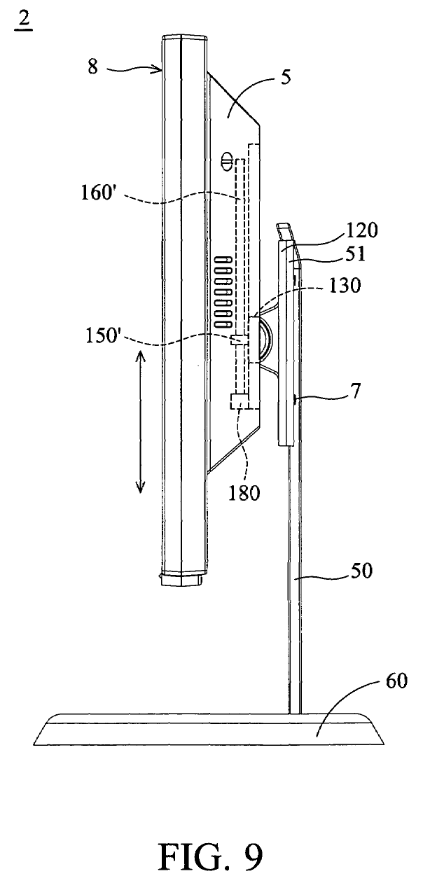

In FIG. 9, the elevation mechanism comprises a guide element 150′, a track 160′ and a motor 180. The guide element 150′ is a nut joined to the connecting element 130. The track 160′ is a screw bar disposed in the main body 8. The nut engages the screw bar, and the motor 180 is joined to one end of the track 160′ to rotate the track 160′. When the support element 120 and the connecting element 13a are fixed to the bracket 50 or the wall W, the guide element 150′ is joined to the connecting element 130. When the track (screw bar) 160′ rotates clockwise or counterclockwise, the track 160′ moves relative to the guide element 150′ to move the main body 8 up and down.

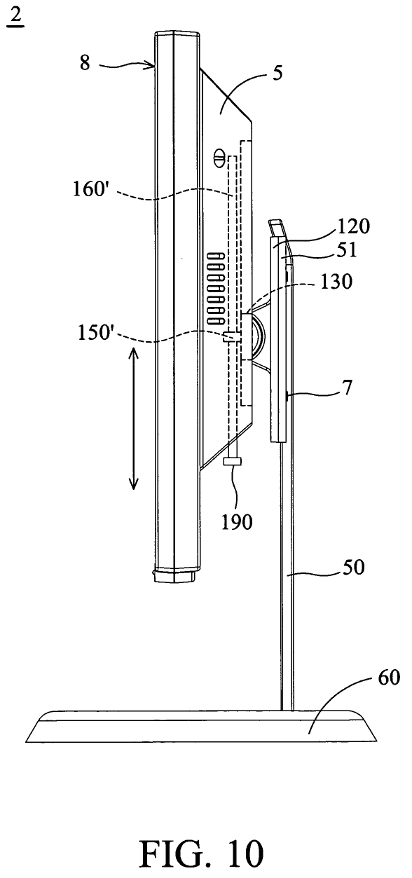

In FIG. 10, the elevation mechanism comprises a guide element 150′, a track 160′ and a handle 190. The structures of the guide element 150′ and the track 160′ are the same as in FIG. 9. The motor 180 in FIG. 9 is replaced by a handle 190. The track. 160′ can be rotated clockwise or counterclockwise by rotating the handle 190, whereby the track 160′ moves relative to the guide element 150′ to move the main body 8 up and down.

The invention discloses a mechanism for moving, rotating or adjusting angle of a display device which, disposed in the display device rather than on a bracket, provides movement, rotation, or adjustment to any position, even on a wall. The elevation mechanism of the invention is not limited. Motors, gears, racks or constant force springs can be used. The mechanism for rotating the display device 2 relative to the support element 120, or the mechanism for adjusting angle is not limited, as long as it is disposed in the display device.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A support structure disposed for a display device, comprising:
a connecting element slidably disposed on the display device; and
a support element joined to the connecting element to adjust an inclined angle of the display device, wherein when the support element is fixed to a predetermined position other than on the display device, the display device is capable of moving up and down with respect to the position.

2. The support structure as claimed in claim 1, wherein the connecting element comprises:
a first portion rotatably connected to the support element; and
a second portion slidably disposed on the display device and rotatably connected to the first portion, wherein the display device rotates clockwise or counterclockwise with respect to the support element via the first portion, and the inclined angle of the display device is adjusted via the second portion.

3. The support structure as claimed in claim 2, wherein the first portion has a disc-shaped rotating portion rotatably joined to the support element.

4. The support structure as claimed in claim 2, wherein the second portion comprises a shaft parallel to the display device, the first portion rotatably connected to the second portion by the shaft.

5. The support structure as claimed in claim 1 further comprising an elevation mechanism disposed in the display device and joined to the connecting element, whereby the display device is capable of moving up and down with respect to the support element.

6. The support structure as claimed in claim 5, wherein the elevation mechanism comprises:
a guide element joined to the support element;
a track disposed on the display device, to which the guide element is slidably joined, wherein when the track moves relative to the guide element, the display device moves up and down.

7. The support structure as claimed in claim 6, wherein the elevation mechanism further comprises a constant force spring disposed on the display device with one end joined to the guide element, and when the guide element moves relative to the guide element, potential of the constant force spring balances the weight of the display device.

8. The support structure as claimed in claim 6, wherein the elevation mechanism further comprises a motor joined to the track which is a screw bar, and when the motor rotates the track, the track moves up and down relative to the guide element to move the display device up and down.

9. The support structure as claimed in claim 6, wherein the elevation mechanism further comprises a handle disposed at one end of the track which is a crew bar, and when the handle is rotated, the track moves up and down relative to the guide element to move the display device up and down.

10. The support structure as claimed in claim 1 further comprising a bracket on which the support element is fixed, and a base on which the bracket is perpendicularly fixed, maintained at a predetermined angle with respect to the bracket.

11. A display device comprising:
a main body; and
a support structure comprising:
a connecting element slidably disposed on the main body; and
a support element joined to the connecting element to adjust an inclined angle of the main body, wherein when the support element is fixed to a predetermined position other than on the main body, the main body is capable of moving up and down with respect to the position.

12. The display device as claimed in claim 11, wherein the connecting element comprises:
a first portion rotatably connected to the support element; and
a second portion slidably disposed on the main body and rotatably connected to the first portion, wherein the main body rotates clockwise or counterclockwise with respect to the support element via the first portion, and the inclined angle of the main body is adjusted via the second portion.

13. The display device as claimed in claim 12, wherein the first portion has a disc-shaped rotating portion rotatably joined to the support element.

14. The display device as claimed in claim 12, wherein the second portion comprising a shaft parallel to the main body, by which the first portion is rotatably connected to the second portion.

15. The display device as claimed in claim 11, wherein the main body has a recess in which the connecting element is slidably disposed.

16. The display device as claimed in claim 15, wherein the recess has a groove in which the connecting element slidably engages.

17. The display device as claimed in claim 11 further comprising an elevation mechanism disposed in the main body and joined to the connecting element, whereby the main body is capable of moving up and down with respect to the support element.

18. The display device as claimed in claim 17, wherein the elevation mechanism comprises:
a guide element joined to the support element; and
a track disposed on the main body, to which the guide element is slidably joined, wherein when the track moves relative to the guide element, the main body moves up and down..

19. The display device as claimed in claim 18, wherein the elevation mechanism further comprises a constant force spring disposed on the main body with one end joined to the guide element, and when the guide element moves relative to the guide element, potential of the constant force spring balances the weight of the display device.

20. The display device as claimed in claim 18, wherein the elevation mechanism further comprises a motor joined to the track which is a screw bar, and when the motor rotates the track, the track moves up and down relative to the guide element to move the display device up and down.

21. The display device as claimed in claim 18, wherein the elevation mechanism further comprises a handle disposed at one end of the track which is a screw bar, and when the handle is rotated, the track moves up and down relative to the guide element to move the display device up and down.

22. The display device as claimed in claim 14 further comprising a bracket on which the support element is fixed, and a base on which the bracket is perpendicularly fixed, and the base is maintained at a predetermined angle with respect to the bracket.
